(19) United States
(12) Patent Application Publication
(10) Pub. No.: US 2003/0037745 A1
(43) Pub. Date: Feb. 27, 2003

(54) Connection of wire to printed circuit board (PCB)

(76) Inventors: Viorel N. Moga, Anderson, IN (US); Emanuel S. Felicio, Montijo (PT); Rick E. Funkhouser, Munice, IN (US)

Correspondence Address: MARGARET A. DOBROWITSKY, DELPHI TECHNOLOGIES, INC., 4TH FLOOR, 1450 W. LONG LAKE ROAD, TROY, MI, 48098, US

(21) Appl. No.: 09/938,991

(22) Filed: Aug. 24, 2001

(51) Int. Cl. F02P 1/00

(52) U.S. Cl. 123/143 C; 123/635

(57) ABSTRACT

A printed circuit board (PCB) for an ignition apparatus includes a connection interface. The connection interface includes a first hole, and a second hole that is smaller than the first hole. The second hole has a pad associated therewith that is electrically coupled to a conductive trace for connecting to a system connector. The first hole and the second hole are coupled by way of a channel. The first hole is sized so as to facilitate insertion of a winding end, while the second hole is configured to facilitate a soldering operation of the winding end to the pad. The channel width is less than the diameter of the winding end so that once the winding end is in the smaller hole, the channel provides, in-effect, a retaining feature until it can be soldered.

### BACKGROUND OF THE INVENTION

1. TECHNICAL FIELD

The present invention relates generally to an ignition apparatus for developing a spark firing voltage that is applied to one or more spark plugs of an internal combustion engine.

2. DISCUSSION OF THE BACKGROUND ART

Ignition coils are known for use in connection with an internal combustion engine, such as an automobile engine. An ignition coil conventionally includes a primary winding having first and second ends, a secondary winding containing a low voltage end and a high voltage end, and a magnetic circuit. In a common arrangement, one or more ignition coils are included as part of an overall ignition apparatus that includes a cartridge or cassette unit having a system connector for connection to a main control unit, such as an engine control unit. One way to connect one or more of the winding ends to the system connector is through a printed circuit board (PCB), as seen by reference to U.S. Pat. No. 5,364,279 issued to Betz et al. entitled “FASTENING ARRANGEMENT FOR CONNECTIONS AT IGNITION COILS FOR MOTOR VEHICLES.” Betz et al. disclose a printed circuit board having a plurality of conductor paths electrically insulated from each other wherein each of the conductor paths has at least two bore holes for electrical connection to a primary winding. The PCB of Betz et al. further includes a plurality of tongue-shaped contacts each having a pin for making an electrical connection between the PCB and a control. The bore holes of Betz et al. are disclosed as being only slightly larger than the diameter of the winding, which is received in the bore. One problem, however, with the connection arrangement of Betz et al. is that since the bore hole for receiving the winding ends is relatively small, the difficulty in assembly is significantly increased. Moreover, to the extent the bore hole is increased in size to ease assembly, the quality of the resulting solder connection of the winding end to the PCB is decreased. That is, the increased free space between the outside diameter of the winding and the inside diameter of the bore is more difficult to reliably fill with solder.

There is therefore a need for an improved connection mechanism for an ignition apparatus that minimizes or eliminates one or more of the problems set forth above.

### SUMMARY OF THE INVENTION

An object of the present invention is to solve one or more of the problems as set forth above. An ignition apparatus according to the present invention overcomes the shortcomings of conventional ignition apparatus, particularly internal connection mechanisms included therein, which makes assembly difficult. An ignition apparatus according to the invention includes a printed circuit board having an improved connection interface for connecting winding ends of an ignition coil thereof to a system connector or the like. The present invention is guided by the need for a larger hole to ease assembly, and further the need to reduce the size of the hole to improve a solder bond quality. According to the invention, a connection interface is provided that solves problems associated with conventional approaches by separating the two functions of the hole, namely, that of receiving the wire during assembly, and that of bonding the wire during a soldering operation.

An ignition apparatus according to the present invention, therefore, includes an ignition coil with at least one winding, and a printed circuit board. The printed circuit board (PCB) has a first hole with a first pad associated therewith. The PCB further includes a second hole with a second pad associated therewith and which is configured to receive an end of the winding referred to above. A conductive trace is provided for connection of the first pad to the second pad. In a preferred embodiment, for example, the first hole may be used to receive a conductive terminal that is a part of a system connector. According to the invention, the PCB further includes a third hole that is adjacent to the second hole. The third hole is larger than the second hole. A channel is also provided that couples the second and the third hole. The second hole, the channel and the third hole together define a connection interface. The diameter of the third hole is selected to facilitate the assembly process wherein an end of the winding is inserted in the third hole. The smaller second hole, on the other hand, has a diameter that is selected to facilitate and improve the quality of a soldering operation. Through the foregoing, ease of assembly is improved, while optimizing the solder bond quality.

A method of assembling an ignition apparatus with at least one winding is also presented.

### BRIEF DESCRIPTION OF THE DRAWINGS

The present invention will now be described by way of example, with reference to the accompanying drawings.

FIG. 1 is a simplified, perspective view of an ignition apparatus according to the present invention.

FIG. 2 is a simplified, enlarged view showing, in greater detail, a portion of a printed circuit board (PCB) of FIG. 1, during an initial winding end insertion phase.

FIG. 3 is the printed circuit board of FIG. 2 after the insertion phase, but prior to a soldering phase.

FIG. 4 is a simplified, cross-sectional view showing, in greater detail, an exemplary ignition coil portion of the ignition apparatus of FIG. 1.

### DETAILED DESCRIPTION OF THE PREFERRED EMBODIMENTS

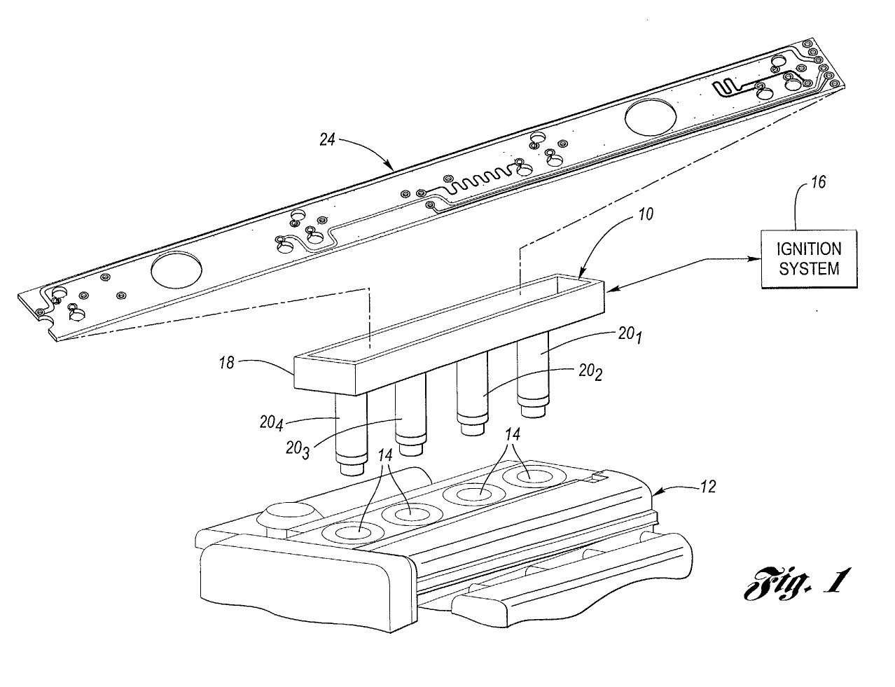

Referring now to the drawings wherein like reference numerals are used to identify identical components in the various views, FIG. 1 is a simplified, perspective view of an ignition apparatus 10 in accordance with the present invention. Ignition apparatus 10 is adapted for installation to a conventional internal combustion engine 12. Internal combustion engine 12 may include a plurality of spark plug access wells 14. In the embodiment shown in FIG. 1, ignition apparatus 10 is configured for installation by disposing distal ends of the ignition apparatus through wells 14 onto a respective high-voltage terminal of a spark plug, which in turn may be retained by a threaded engagement with a spark plug opening in a combustion cylinder in engine 12. Engine 12 may provide power for locomotion of a self-propelled vehicle, such as an automotive vehicle.

FIG. 1 further shows an ignition system 16. As is generally known, ignition apparatus 10 may be coupled to, for example, ignition system 16, which may contain primary energization circuitry for controlling the charging and discharging of ignition apparatus 10, particularly, individual ignition coils thereof. The relatively high voltage produced by ignition apparatus 10 is provided to one or more spark plugs for producing a spark across a spark gap thereof which, as known, may be employed to initiate combustion in the combustion chamber of the engine.

Ignition system 16 may comprise an engine control unit (ECU), or the like containing electronics and other conventional hardware and software. System 16, as known, may be configured to determine when charging of a particular coil is to commence for each cylinder, and for how long, and when spark events should occur relative to a crankshaft position. Additionally, system 16 generates such electrical signals as required to implement an operating strategy as outlined above. In all respects, ignition system 16 may comprise conventional apparatus known to those of ordinary skill in the art, and will not be described in any further detail.

With continued reference to FIG. 1, ignition apparatus 10 includes a housing or cassette 18, a plurality of ignition coils, designated 20₁, 20₂, 20₃, . . . 20₄ (i.e., four shown), a system connector 22 (best shown in FIG. 4) and a printed circuit board (PCB) 24.

Cassette 18 in the illustrated embodiment, is configured to receive PCB 24, as well as certain winding ends from the plurality of ignition coils, to be described in greater detail below. Cassette 18 is known generally in the art, as seen by reference to U.S. Pat. No. 4,706,639 issued to Boyer et al. entitled “INTEGRATED DIRECT IGNITION MODULE” herein incorporated by reference in its entirety. Cassette 18 is further configured to receive, after the assembly of printed circuit board 24, an encapsulant, as known to provide electrical insulation, as well as provide environmental insulation from elements that apparatus 10 may encounter during its service life.

Ignition coils 20₁, 20₂, 20₃, . . . 20₄ have a relatively slender configuration adapted for mounting directly above the spark plug—commonly referred to as a “pencil” coil. It should be understood, however, that the improvements occasioned by the present invention are not so limited, and may be applied to other apparatus, including other ignition apparatus, wherein winding ends are to be connected to a PCB. Although a more detailed description of an exemplary ignition coil 20 will be set forth in greater detail in connection with FIG. 4, each ignition coil 20 includes at least one winding, and in the illustrated embodiment, includes a primary winding, a secondary winding, and a magnetic circuit. The primary winding includes a first end that is connected to a power supply, such as a vehicle battery, designated B+ in the drawings. The primary winding further includes a second end configured for connection to a switch, such end being designated herein as C−. As known generally, the switch is controlled to selectively connect the second end of the primary winding to ground, to thereby establish a primary current through the primary winding for charging the ignition coil. The secondary winding of each ignition coil includes a high voltage end which is electrically connected to a high voltage connector assembly (for connection to a spark plug), and a low voltage end. The low voltage end of the secondary winding is conventionally coupled to an electrical ground node.

PCB 24 is configured to the couple winding ends described above to system connector 22. System connector provides connections to system 16.

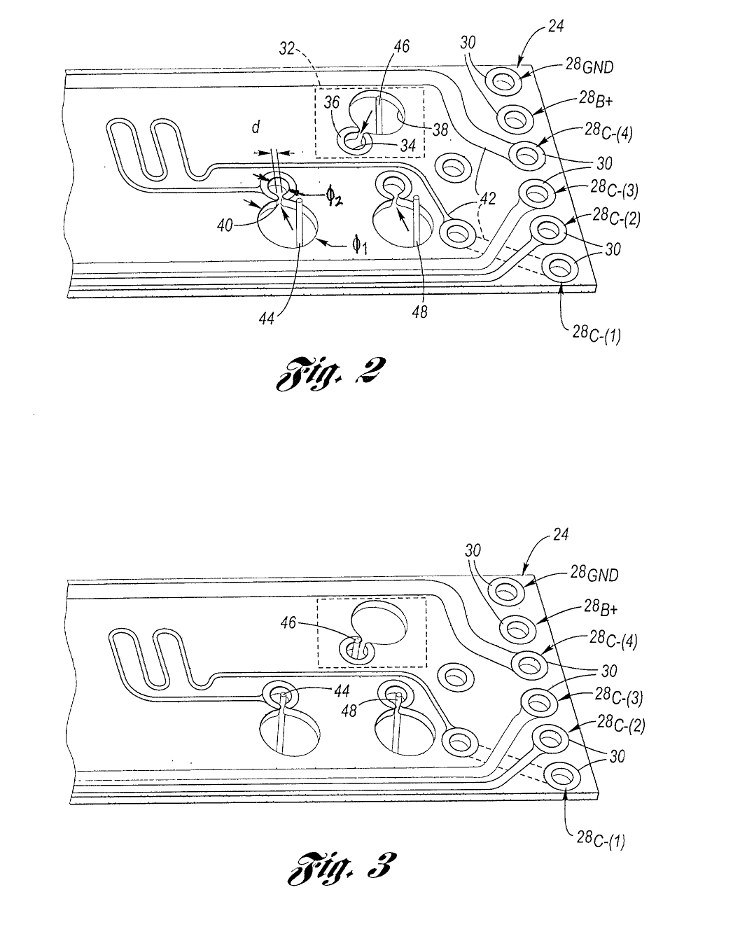

FIG. 2 shows a portion of PCB 24 in greater detail. PCB 24 includes an electrically insulative substrate 26, a plurality of system connector holes 28 (to be described in greater detail below) having a corresponding plurality of pads 30 associated therewith, and a plurality of connection interfaces 32 each interface comprising a first hole 34 having a first pad 36 associated therewith, a second hole 38 and a channel 40 coupled therebetween. PCB 24 further includes a plurality of conductive traces 42 (each electrically insulated from each other).

Substrate 26 may comprise conventional materials known to those of ordinary skill in the art, such as, for example, as described in U.S. Pat. No. 5,364,279 issued to Betz et al. described in the Background. It should be understood, however, that a wide variety of electrically insulative substrate materials may be used, having due consideration for the relatively high temperature environment in which PCB 24 will be deployed (i.e., in one embodiment, an engine compartment of engine 12).

PCB 24 includes a plurality of system connector holes 28 configured to receive conductive terminals associated with system connector 22 (one such terminal, designated by reference numeral 166, is shown in FIG. 4). The system connector holes 28 provide, in-part, a mechanism for electrically connecting the winding ends of ignition coils 20 to conventional power source signals, and control signals. As shown in FIG. 2, the system connector holes may include a hole 28_{GND}, which is used to couple a ground node to PCB 24, a hole 28_{B+}, which is used to couple a power source, such as a positive vehicle battery rail, to PCB 24, and a plurality of so-called “C−” connections 28_{C-(4)}, 28_{C-(3)}, 28_{C-(2)}, and 28_{C-(1)}. These so-called “C−” connections conventionally are for coupling to a switch an end of the primary winding opposite the B+ end. The number in parentheses indicates a cylinder number (e.g, 28_{C-(3)} is for cylinder number 3, 28_{C-(1)} is for cylinder number 1, etc.). The switch is controlled to selectively connect such end to ground (as known in the art). That is, in the illustrated embodiment, circuitry in ignition system 12 includes switches, such as semiconductor switches, for example, insulated gate bipolar transistors (IGBT), MOSFET devices, and the like, which selectively connect the low end of the primary winding to ground. Such connection, as is known, establishes a primary current I_{P} through the primary winding, thereby charging the ignition coil.

In accordance with the invention, PCB 24 further includes a plurality of connection interfaces 32. As shown in FIG. 2, one such connection interface is enclosed in a dashed-line box. The three connection interfaces 32 shown in FIG. 2 are part of a first group configured to connect both ends of the primary winding, and the low voltage end of the secondary winding associated with one ignition coil 20₁ to the system connector holes 28 via traces 42, and perhaps intervening through holes. As best shown in FIG. 1, PCB 24, in the illustrated embodiment, includes four groups of three connection interfaces 32, one group for each of the four ignition coils 20₁, 20₂, 20₃, . . . 20₄.

Hole 34 is circular in shape and has a diameter Φ₂ that is selected to facilitate a soldering operation of an end of a winding (e.g., as illustrated, one of the winding 44, 46, or 48) to pad 36. The second hole 38 is also circular in shape and has a diameter Φ₁ that is selected to facilitate an assembly process wherein the end of one of the windings 46, 44, or 48 is inserted in the hole 38. The channel 40 has a width, designated “d” in the drawings, that is selected to be less than the wire diameter of the winding end. In a preferred embodiment, the diameter of hole 34 is selected to be only slightly larger than the wire diameter so that the free space between the outside diameter of the winding end and the inside diameter of hole 34 is relatively small (reduced), thereby providing for a high quality solder bond.

With continued reference to FIG. 2, in operation, the ends of windings 44, 46, and 48 are located under the larger hole 38 of each one of the connection interfaces 32, facilitating the insertion of such ends through hole 38 of PCB 24. The PCB 24 is then set down wherein the ends are easily received in the holes 38. Thereafter, the ends of windings 44, 46, and 48 may be pushed, either manually by an operator, or automatically by a machine so configured, in the general direction of the arrows in FIG. 2. The wires must pass through the tight channel 40 and then into the smaller hole 34. Since the width of the channel is smaller than the wire diameter, the wire, in-effect, is “snapped” into the smaller hole 34. Significantly, the channel, being smaller than the wire diameter, prevents the winding end from moving back through the channel into the larger hole. Such an arrangement, therefore, provides a retaining function of the winding end in the smaller hole 34 until it can be soldered.

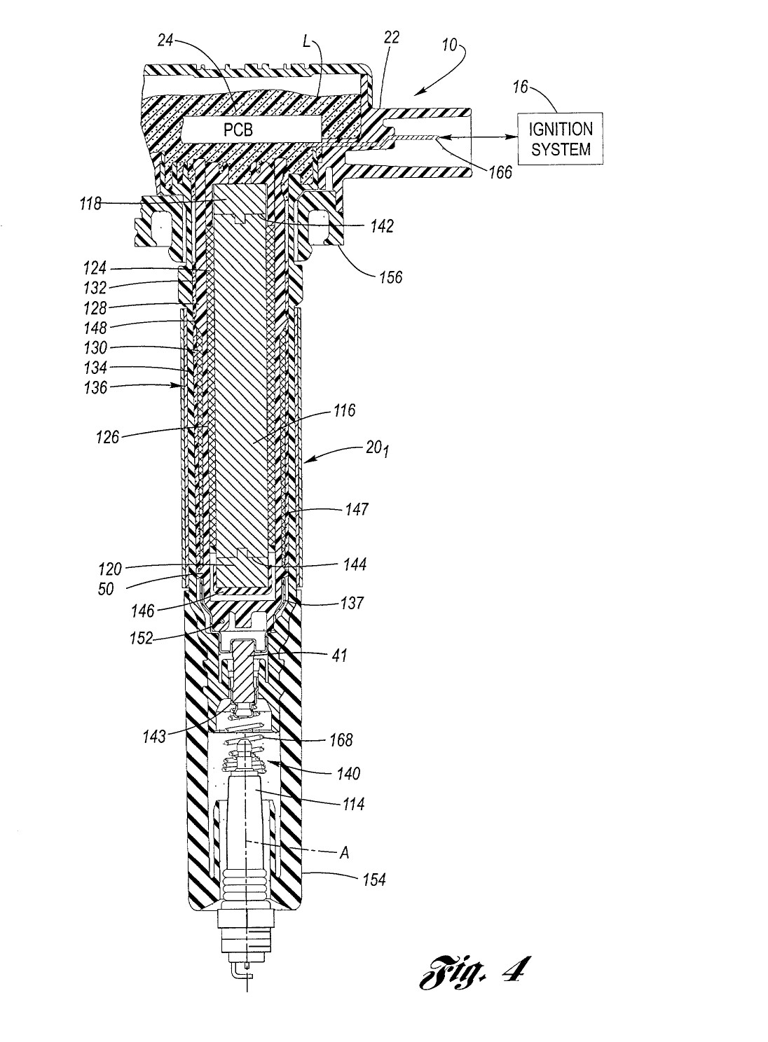

FIG. 3 shows PCB 24 after the ends of windings 44, 46, and 48 have been “snapped” through channels 40 into respective smaller holes 34. The smaller hole 34 can be kept of a small diameter to improve the quality of the subsequent soldering operation.

The method according to the present invention provides for a more reliable assembly of PCB 24 into cassette 18 over the ends of the windings, for example, windings 44, 46, and 48. The quality of the solder bonds between the ends of windings 44, 46, and 48 and the printed circuit board 24 are also improved. In addition, the relative distance between the ends of windings 44, 46, and 48 do not have to be as tightly controlled (i.e., kept to relatively small tolerances) as compared with conventional approaches that employ only a single size hole.

FIG. 4 is a simplified, partial section view through ignition coil 20₁ of apparatus 10 that shows an exemplary system connector 22 illustrating one of a plurality of conductive terminals 166 coupled to PCB 24. The connection to PCB 24 of the ends of the windings described and illustrated in connection with FIGS. 2-3 have been omitted for clarity.

Referring now to FIG. 4, further details concerning an exemplary ignition coil 20₁ will now be set forth. It should be understood that portions of the following are exemplary only and not limiting in nature. Coils 20₂, 20₃, and 20₄ may be the same. Many other configurations of coils 20 are known to those of ordinary skill in the art and are consistent with the teachings of the present invention, which relate principally to the inventive connection arrangement. Nonetheless, the following may be taken as a non-limiting illustrated embodiment.

Central core 116 may be elongated, having a main, longitudinal axis “A” associated therewith. Core 116 includes an upper, first end 142, and a lower, second end 144. Core 116 may be a conventional core known to those of ordinary skill in the art. As illustrated, core 116, in the preferred embodiment, takes a generally cylindrical shape (which is a generally circular shape in radial cross-section), and may comprise compression molded insulated iron particles or laminated steel plates, both as known.

Magnets 118 and 120 may be optionally included in ignition coil 20₁ as part of the magnetic circuit, and provide a magnetic bias for improved performance. The construction of magnets such as magnets 118 and 120, as well as their use and effect on performance, is well understood by those of ordinary skill in the art. It should be understood that magnets 118 and 120 are optional in ignition coil 20₁, and may be omitted, albeit with a reduced level of performance, which may be acceptable, depending on performance requirements.

A rubber buffer cup 146 may be included.

Primary winding 124 may be wound directly onto core 116 in a manner known in the art. Primary winding 124 includes first and second ends and is configured to carry a primary current I_{P} for charging coil 20₁ upon control of ignition system 16. Winding 124 may be implemented using known approaches and conventional materials. Although not shown, primary winding 124 may be wound on a primary winding spool (not shown) in certain circumstances (e.g., when steel laminations are used). In addition, winding 124 may be wound on an electrically insulating layer that is itself disposed directly on core 116.

Layers 126 and 132 comprise an encapsulant suitable for providing electrical insulation within ignition coil 20₁. In a preferred embodiment, the encapsulant comprises epoxy potting material. The epoxy potting material introduced in layers 126, and 132 may be introduced into annular potting channels defined (i) between primary winding 124 and secondary winding spool 128, and, (ii) between secondary winding 130 and case 134. The potting channels are filled with potting material, in the illustrated embodiment, up to approximately the level designated “L” in FIG. 4. In one embodiment, layer 126 may be between about 0.1 mm and 1.0 mm thick. Of course, a variety of other thicknesses are possible depending on flow characteristics and insulating characteristics of the encapsulant and the design of the coil 20₁. The potting material also provides protection from environmental factors which may be encountered during the service life of ignition coil 20₁. There is a number of suitable epoxy potting materials well known to those of ordinary skill in the art.

Secondary winding spool 128 is configured to receive and retain secondary winding 130. Spool 128 is disposed adjacent to and radially outwardly of the central components comprising core 116, primary winding 124, and epoxy potting layer 126, and, preferably, is in coaxial relationship therewith. Spool 128 may comprise any one of a number of conventional spool configurations known to those of ordinary skill in the art. In the illustrated embodiment, spool 128 is configured to receive one continuous secondary winding (e.g., progressive winding) on an outer winding surface thereof, between upper and lower flanges 148 and 150 (“winding bay”), as is known. However, it should be understood that other configurations may be employed, such as, for example only, a configuration adapted for use with a segmented winding strategy (e.g., a spool of the type having a plurality of axially spaced ribs forming a plurality of channels therebetween for accepting windings) as known.

The depth of the secondary winding in the illustrated embodiment may decrease from the top of spool 128 (i.e., near the upper end 142 of core 116), to the other end of spool 128 (i.e., near the lower end 144) by way of a progressive gradual flare of the spool body. The result of the flare or taper is to increase the radial distance (i.e., taken with respect to axis “A”) between primary winding 124 and secondary winding 130, progressively, from the top to the bottom. As is known in the art, the voltage gradient in the axial direction, which increases toward the spark plug end (i.e., high voltage end) of the secondary winding, may require increased dielectric insulation between the secondary and primary windings, and, may be provided for by way of the progressively increased separation between the secondary and primary windings.

Spool 128 is formed generally of electrical insulating material having properties suitable for use in a relatively high temperature environment. For example, spool 128 may comprise plastic material such as PPO/PS (e.g., NORYL available from General Electric) or polybutylene terephthalate (PBT) thermoplastic polyester. It should be understood that there are a variety of alternative materials that may be used for spool 128 known to those of ordinary skill in the ignition art, the foregoing being exemplary only and not limiting in nature.

Features 148 and 150 may be further configured so as to engage an inner surface of case 134 to locate, align, and center the spool 128 in the cavity of case 134 and providing upper and lower defining features for a winding surface therebetween.

Spool 128 has associated therewith an electrically conductive (i.e., metal) high-voltage (HV) terminal 152 disposed therein configured to engage cup 137, which cup is in turn electrically connected to the HV connector assembly 140. The body of spool 128 at a lower end thereof is configured so as to be press-fit into the interior of cup 137 (i.e., the spool gate portion).

FIG. 4 also shows secondary winding 130 in cross-section. Secondary winding 130, as described above, is wound on spool 128, and includes a low voltage end and a high voltage end. The low voltage end may be connected to ground by way of a ground connection through LV system connector body 22 in a manner known to those of ordinary skill in the art. The high voltage end is connected to HV terminal 152. Winding 130 may be implemented using conventional approaches and material known to those of ordinary skill in the art.

Case 134 includes an inner, generally enlarged cylindrical surface, an outer surface, a first annular shoulder, a flange, an upper through-bore, and a lower through bore.

The inner surface of case 134 is configured in size to receive and retain spool 128 which contains the core 116 and primary winding 124. The inner surface of case 134 may be slightly spaced from spool 128, particularly the annular features 148, 150 thereof (as shown), or may engage the features 148, 150.

A lower through-bore is defined by an inner surface of case 134 configured in size and shape (i.e., generally cylindrical) to accommodate an outer surface of cup 137 at a lowermost portion thereof as described above. When the lowermost body portion of spool 128 is inserted in the lower bore containing cup 137, a portion of HV terminal 152 engages an inner surface of cup 137 (also via a press fit).

Case 134 is formed of electrical insulating material, and may comprise conventional materials known to those of ordinary skill in the art (e.g., the PBT thermoplastic polyester material referred to above).

Shield 136 is generally annular in shape and is disposed radially outwardly of case 134, and, preferably, engages an outer surface of case 134. The shield 136 preferably comprises electrically conductive material, and, more preferably metal, such as silicon steel or other adequate magnetic material. Shield 136 provides not only a protective barrier for ignition coil 20₁ generally, but, further, provides a magnetic path for the magnetic circuit portion of ignition coil 20₁. Shield 136 may be grounded by way of an internal grounding strap, finger or the like (not shown) well know to those of ordinary skill in the art. Shield 136 may comprise multiple, individual sheets 136, as shown.

Low voltage system connector body 22 is configured to, among other things, electrically and selectively connect the first and second ends of primary winding 124 via PCB 24 as described above to an energization source, such as, the energization circuitry (e.g., power source) included in ignition system 16. Connector 22 also provides in-part, a mechanism for grounding the LV end of secondary winding. System connector body 22 is generally formed of electrical insulating material, but also includes a plurality of electrically conductive output terminals 166 (e.g., pins for ground, primary winding leads, etc.). Terminals 166 are coupled electrically, internally through connector body 22 via PCB 24.

HV connector assembly 140 is provided for establishing an electrical connection to spark plug 114. Assembly 140 may include an inductive resistor 141, a second conductive cup 143 and a spring contact 168 or the like. Resistor 141 may be provided to combat electromagnetic interference (EMI). Second cup 143 provides for a transition to spring 168. Cup 143 may include an annular projection configured to allow spring 168 to be coupled thereto. Contact spring 168 is in turn configured to engage a high-voltage connector terminal of spark plug 114. This arrangement for coupling the high voltage developed by secondary winding 130 to plug 114 is exemplary only; a number of alternative connector arrangements, particularly spring-biased arrangements, are known in the art.

1. An apparatus comprising:
an ignition coil with at least one winding;
a printed circuit board (PCB) having a first hole with a first pad associated therewith, a second hole with a second pad associated therewith and configured to receive an end of said winding, a conductive trace for connecting said first pad to said second pad, a third hole adjacent to said second hole, said third hole being larger than said second hole, and a channel coupling said second hole and said third hole.

2. The apparatus of claim 1 wherein said first hole is configured to receive a conductive terminal.

3. The apparatus of claim 2 wherein said first hole is circular in shape having a first diameter selected to facilitate a soldering operation of said conductive terminal to said first pad.

4. The apparatus of claim 1 wherein said second hole is circular in shape having a second diameter selected to facilitate a soldering operation of said end of said winding to said second pad.

5. The apparatus of claim 1 wherein said third hole is circular in shape having a third diameter selected to facilitate an assembly process wherein said end of said winding is inserted in said third hole.

6. The apparatus of claim 5 wherein said channel has a width that is selected to be less than a wire diameter of said end of said winding.

7. The apparatus of claim 1 wherein said second hole, said third hole and said channel define a connection interface, said PCB having a plurality of connection interfaces.

8. The apparatus of claim 7 wherein said winding is a primary winding, said end is a first end of said primary winding, said primary winding having a second end, said ignition coil further having a secondary winding with a high voltage end and a low voltage end, said PCB having a respective one of said connection interfaces for said first and second ends of said primary winding and said low voltage end of said secondary winding.

9. The apparatus of claim 8 wherein said connection interfaces for said ignition coil define a group, said apparatus further including a plurality of ignition coils, said PCB including a corresponding plurality of groups of connection interfaces.

10. An ignition apparatus comprising:
a plurality of ignition coils, each ignition coil having at least a primary winding having first and second ends, and a secondary winding having a high voltage end and a low voltage end;
a cassette for coupling said plurality of coils, said cassette including (i) a printed circuit board (PCB) and (ii) a system connector for connection to a control unit, said PCB including, for said first and second ends of said primary winding and said low voltage end of said secondary winding of each ignition coil, a respective connection interface, each connection interface comprising a first hole having a first pad associated therewith, a second hole adjacent to said first hole wherein said second hole is larger than said first hole, and a channel coupling said first and second holes, said PCB further including a plurality of holes with corresponding pads associated therewith for connection to terminals defining said system connector, said connection interfaces being electrically connected to said system connector via conductive traces on said PCB.

11. A method of assembling an ignition apparatus with at least one winding, comprising the steps of:
(A) providing a printed circuit board (PCB) having a first hole with a first pad associated therewith, a second hole with a second pad associated therewith, a conductive trace connecting said first and second pads, a third hole adjacent to said second hole, and a channel coupling said second hole and said third hole wherein said third hole is larger than said second hole;
(B) inserting an end of said winding in said third hole;
(C) moving said end through said channel to said second hole; and
(D) electrically connecting said end to said second pad.

12. The method of claim 11 further comprising the step of:
selecting a first diameter of said first hole configured to facilitate a soldering operation coupling said first pad and a conductive terminal.

13. The method of claim 11 further comprising the step of:
selecting a second diameter of said second hole configured to facilitate a soldering operation coupling said second pad and said end of said winding.

14. The method of claim 11 further comprising the step of:
selecting a third diameter of said third hole configured to facilitate said inserting an end of said winding step.
